(19) United States
(12) Patent Application Publication
(10) Pub. No.: US 2025/0173052 A1
(43) Pub. Date: May 29, 2025

(54) METHOD FOR ARRANGING REGIONAL ELEMENT, MACHINE, SYSTEM, AND STORAGE MEDIUM

(71) Applicant: Makeblock Co., Ltd., Shenzhen (CN)

(72) Inventors: Shiling WU, Shenzhen (CN); Chen YANG, Shenzhen (CN)

(73) Assignee: Makeblock Co., Ltd., Shenzhen (CN)

(21) Appl. No.: 18/943,027

(22) Filed: Nov. 11, 2024

(30) Foreign Application Priority Data
Nov. 24, 2023 (CN) 202311594534.7
Aug. 9, 2024 (CN) 202411092400.X

(51) Int. Cl. G06F 3/04845; G05B 19/402; G05B 19/4099

(52) U.S. Cl. CPC G06F 3/04845; G05B 19/402; G05B 19/4099; G05B 2219/32128

(57) ABSTRACT

Disclosed are a method for arranging a regional element, a machine, a system, and a storage medium. The method includes: determining a target processing graphic element on a display interface according to a received first operation instruction; and determining an alignment reference object, and in response to a second operation instruction, controlling the target processing graphic element to move to a target position of the alignment reference object after determining the target position of the alignment reference object, to align the target processing graphic element with the target position. The second operation instruction is configured to specify a target position to be aligned of the target processing graphic element.

### CROSS-REFERENCE TO RELATED APPLICATIONS

This application claims priority to Chinese Patent Application No. 202311594534.7, filed on Nov. 24, 2023, and Chinese Patent Application No. 202411092400.X, filed on Aug. 9, 2024. All of the aforementioned applications are incorporated herein by reference in their entireties.

### TECHNICAL FIELD

The present application relates to the technical field of computers, and in particular to a method for arranging a regional element, a machine, a system, and a storage medium.

### BACKGROUND

In the current scheme for arranging elements, which is applied to design software or laser software, the alignment reference object such as the processing region created by the existing design software or the laser software, is only used as a reference auxiliary region and cannot be edited during the element layout process. Besides, the target processing graphic elements moved to the alignment reference objects are inconvenient to adjust the setting position, resulting in low layout efficiency.

### SUMMARY

The main purpose of the present application is to provide a method for arranging the regional element, a machine, a system, and a storage medium, aiming to solve the problem that during the arrangement process of the existing scheme for arranging the regional element, the target processing graphic element cannot be accurately moved to the target position where the target processing graphic element is required to be aligned, it is inconvenient to adjust the setting position of the target processing graphic element, and the arrangement efficiency is low.

In order to achieve the above objectives, the present application provides a method for arranging the regional element, including:
determining a target processing graphic element on a display interface according to a received first operation instruction; and
determining an alignment reference object, and in response to a second operation instruction, controlling the target processing graphic element to move to a target position of the alignment reference object after determining the target position of the alignment reference object, to align the target processing graphic element with the target position, where the second operation instruction is configured to specify a target position to be aligned of the target processing graphic element.

In an embodiment, in response to the second operation instruction, controlling the target processing graphic element to move to the target position of the alignment reference object after determining the target position of the alignment reference object, to align the target processing graphic element with the target position includes:
determining the target position to be aligned on the alignment reference object in response to the second operation instruction; and
controlling the target processing graphic element to move to the target position to be aligned on the alignment reference object, to align the target processing graphic element with the target position.

In an embodiment, the second operation instruction includes a first operation sub-instruction and a second operation sub-instruction, and the determining the alignment reference object, and in response to the second operation instruction, controlling the target processing graphic element to move to the target position of the alignment reference object after determining the target position of the alignment reference object, to align the target processing graphic element with the target position includes:
displaying a plurality of moving object options, and configuring a moving object determined from the plurality of moving object options as the alignment reference object, where each moving object option corresponds to one moving object displayed on the display interface, and the moving object includes a canvas, a calibrated processing region, a curved surface processing region, and an auxiliary line;
in response to the first operation sub-instruction, displaying at least one position option corresponding to the alignment reference object, where each position option corresponds to one alternative alignment position on the alignment reference object;
in response to the second operation sub-instruction corresponding to a position option, configuring the alternative alignment position determined from the plurality of position options as the target position to be aligned on the alignment reference object; and
controlling the target processing graphic element to move to the target position to be aligned on the alignment reference object, to align the target processing graphic element with the target position.

In an embodiment, the second operation instruction includes a third operation sub-instruction, and the determining the alignment reference object, and in response to the second operation instruction, controlling the target processing graphic element to move to the target position of the alignment reference object after determining the target position of the alignment reference object, to align the target processing graphic element with the target position includes:
displaying a plurality of moving object options, and configuring a moving object determined from the plurality of moving object options as the alignment reference object, where each moving object option corresponds to one moving object displayed on the display interface, and the moving object includes a processing tip calibration position and an alternative calibration point; and
in response to the third operation sub-instruction, configuring the alignment reference object as the target position, and controlling the target processing graphic element to move to the target position, to align the target processing graphic element with the target position.

In an embodiment, a first interactive control member is displayed on the display interface, the second operation instruction includes a fourth operation sub-instruction and a fifth operation sub-instruction, and in response to the second operation instruction, controlling the target processing graphic element to move to the target position of the alignment reference object after determining the target position of the alignment reference object, to align the target processing graphic element with the target position includes:
in response to the fourth operation sub-instruction of the first interactive control member, displaying a plurality of position options on the display interface, each position option corresponding to a sub-region on the alignment reference object; and
in response to the fifth operation sub-instruction of the position option, configuring a sub-region determined from the plurality of position options as the target position, controlling the target processing graphic element to move to the target position, to align the target processing graphic element with the target position.

In an embodiment, the method further includes:
in response to the first operation instruction, creating a processing graphic element and an alignment reference object on the display interface; and
establishing a plurality of target positions on the alignment reference object according to a position parameter of the alignment reference object, and establishing a plurality of alignment anchor points on the processing graphic element, to make positions of the plurality of alignment anchor points on the processing graphic element correspond to positions of the plurality of target positions on the alignment reference object.

In an embodiment, in response to the second operation instruction, controlling the target processing graphic element to move to the target position of the alignment reference object after determining the target position of the alignment reference object, to align the target processing graphic element with the target position includes:
in response to the second operation instruction, determining a corresponding alignment anchor point on the target processing graphic element according to the target position determined by the second operation instruction, and controlling the target processing graphic element to move, to make a corresponding alignment anchor point on the target processing graphic element align and overlap with a determined target position.

In an embodiment, a second interactive control member is displayed on the display interface, the second operation instruction includes a trigger instruction for the second interactive control member, and in response to the trigger instruction for the second interactive control member, controlling the target processing graphic element to move to the target position of the alignment reference object after determining the target position of the alignment reference object, to align the target processing graphic element with the target position includes:
in response to the trigger instruction for the second interactive control member, when a distance between the target processing graphic element and a target position of the alignment reference object is within an adsorption distance, controlling the target processing graphic element to move to the target position of the alignment reference object; or
in response to the trigger instruction for the second interactive control member, when a distance between the target processing graphic element and a plurality of target positions of the alignment reference object is within an adsorption distance, controlling the target processing graphic element to move to a target position closest to the target processing graphic element.

In an embodiment, the second operation instruction includes a movement trigger instruction, and the determining the alignment reference object, and in response to the second operation instruction, controlling the target processing graphic element to move to the target position of the alignment reference object after determining the target position of the alignment reference object includes:
acquiring an actual position of the processing tip, generating a processing tip calibration position corresponding to the actual position of the processing tip on the display interface, and determining the alignment reference object with the processing tip calibration position; and
in response to the movement trigger instruction of the target processing graphic element, configuring the processing tip calibration position as the target position, when a distance between the target processing graphic element and the processing tip calibration position is within an adsorption distance, controlling the target processing graphic element to move to the processing tip calibration position.

In an embodiment, the second operation instruction includes a movement trigger instruction, and in response to the second operation instruction, controlling the target processing graphic element to move to the target position of the alignment reference object after determining the target position of the alignment reference object includes:
in response to the movement trigger instruction of the target processing graphic element, when a distance between the target processing graphic element and a target position of the alignment reference object is within an adsorption distance, controlling the target processing graphic element to move to the target position of the alignment reference object; or when a distance between the target processing graphic element and a plurality of target positions of the alignment reference object is within an adsorption distance, controlling the target processing graphic element to move to a target position closest to the target processing graphic element.

In an embodiment, before in response to the second operation instruction, controlling the target processing graphic element to move to the target position of the alignment reference object after determining the target position of the alignment reference object, to align the target processing graphic element with the target position, the method further includes:
in response to the movement trigger instruction for the target processing graphic element, when a distance between the target processing graphic element and one or a plurality of target positions is within the adsorption distance, highlighting the target position.

In an embodiment, the alignment reference object includes at least one of the following:
a canvas, a calibrated processing region, a curved surface processing region, and an auxiliary line.

In an embodiment, when the alignment reference object is the calibrated processing region, the determining the alignment reference object includes:
based on an actual processing region calibrated through the processing tip, generating a calibrated processing region corresponding to the actual processing region on a canvas of the display interface, and determining a generated calibrated processing region as the alignment reference object.

In an embodiment, after the controlling the target processing graphic element to move to the target position of the alignment reference object, to align the target processing graphic element with the target position, the method further includes:
in response to a third operation instruction, determining a position of the target processing graphic element on the alignment reference object, and generating a scheme for arranging the regional element.

In order to achieve the above objectives, the present application further provides a device for arranging a regional element, including:
a display module provided with a display interface;
a receiving module configured to receive an operation instruction, where the operation instruction includes at least a first operation instruction and a second operation instruction; and
a generating module configured to execute the method for arranging the regional element as mentioned above based on the operation instruction.

In order to achieve the above objectives, the present application further provides a computer numerical control machine, including:
a sliding rail;
a processing tip slidably provided at the sliding rail;
a communication assembly configured to receive a signal, where the signal is obtained through the method for arranging the regional element as mentioned above to align the target processing graphic element with the alignment reference object; and
a controller configured to control the processing tip to move on the sliding rail to process a surface of a processing material based on the signal.

In order to achieve the above objectives, the present application provides a system, including:
at least one data processor;
at least one non-transitory computer-readable storage medium, where a program instruction stored on the non-transitory computer-readable storage medium is executed by the at least one data processor, to make the system be configured to:
determine a target processing graphic element on a display interface according to a received first operation instruction; and
determine an alignment reference object, and in response to a second operation instruction, control the target processing graphic element to move to a target position of the alignment reference object after determine the target position of the alignment reference object, to align the target processing graphic element with the target position, where the second operation instruction is configured to specify the target position of the target processing graphic element to be aligned.

In order to achieve the above objectives, the present application provides a non-transitory computer-readable storage medium, where a computer program is stored on the non-transitory computer-readable storage medium, and when the computer program is executed by a processor, the method for arranging the regional element as mentioned above is implemented.

In order to achieve the above objectives, the present application provides a computer program product, where the computer program product includes a computer program, and when the computer program is executed by a processor, the method for arranging the regional element as mentioned above is implemented.

Compared with the related art, the present application has the following beneficial effects.

The method for arranging the regional element includes: determining a target processing graphic element on a display interface according to a received first operation instruction; and determining an alignment reference object, and in response to a second operation instruction, controlling the target processing graphic element to move to a target position of the alignment reference object after determining the target position of the alignment reference object. In this way, the position of the target processing graphic element in the alignment reference object can be accurately specified, which is convenient for adjustment and can effectively solve the problem of low arrangement efficiency. In addition, the adjustment of the arrangement position of the target processing graphic element can be performed more flexibly, which can not only meet the arrangement requirements of elements in different regions and optimize the user experience, but also can avoid affecting the arrangement effect due to the inability to accurately specify the position of the target processing graphic element in the alignment reference object.

### BRIEF DESCRIPTION OF THE DRAWINGS

To illustrate the technical solutions according to the embodiments of the present application or the related art more clearly, the accompanying drawings for describing the embodiments are introduced briefly in the following. Apparently, the accompanying drawings in the following description are only some embodiments of the present application. Persons of ordinary skill in the art can derive other drawings from the accompanying drawings without creative efforts.

FIG. 1 is a schematic diagram of a method for arranging a regional element applied to a system architecture according to an embodiment of the present application.

FIG. 2 is a flowchart of the method for arranging the regional element according to an embodiment of the present application.

FIG. 3 is a specific flowchart of step S200 of the method for arranging the regional element according to an embodiment of the present application.

FIG. 4 is a specific flowchart of step S200 of the method for arranging the regional element according to another embodiment of the present application.

FIG. 5 is a specific flowchart of step S200 of the method for arranging the regional element according to yet another embodiment of the present application.

FIG. 6 is a specific flowchart of step S200 of the method for arranging the regional element according to yet another embodiment of the present application.

FIG. 7 is a specific flowchart of step S200 of the method for arranging the regional element according to yet another embodiment of the present application.

FIG. 8 is a partial flowchart of the method for arranging the regional element according to another embodiment of the present application.

FIG. 9 is an interface diagram of the method for arranging the regional element according to an embodiment of the present application.

FIG. 10 is an interface diagram of the method for arranging the regional element according to another embodiment of the present application.

FIG. 11 is an interface diagram of the method for arranging the regional element according to yet another embodiment of the present application.

FIG. 12 is an implementation diagram showing generating a calibrated processing region corresponding to an actual processing region on a display interface according to an embodiment of the present application.

FIG. 13 is an implementation diagram showing displaying the distance between a target position and a target processing graphic element on a display interface according to an embodiment of the present application.

FIG. 14 is a schematic structural diagram of a computer numerical control machine according to an embodiment of the present application.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in detail below with reference to the accompanying drawings. It is obvious that the embodiments to be described are only some rather than all of the embodiments of the present application. All other embodiments obtained by persons skilled in the art based on the embodiments of the present application without creative efforts shall fall within the scope of the present application.

It should be noted that all the directional indications in the embodiments of the present application are only used to explain the relative positional relationship, movement, or the like of the components in a certain posture. If the specific posture changes, the directional indication will change accordingly.

Besides, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. When the description of “A and/or B” is used in the present application, it means that either scheme A or scheme B is included, or both scheme A and scheme B are included. In addition, the technical solutions of the various embodiments can be combined with each other, but the combinations must be based on the realization of those skilled in the art. When the combination of technical solutions is contradictory or cannot be achieved, it should be considered that such a combination of technical solutions does not exist, nor does it fall within the scope of the present application.

At present, the scheme for arranging the regional element applied to the design software or the laser software generally have the function of intelligent element adsorption. However, the intelligent element adsorption is mainly used in the adsorption between elements. The alignment reference object such as the processing region created by the existing design software or the laser software is only used as a reference auxiliary region to realize the adsorption between elements. Since the alignment reference object cannot be edited, during the arrangement process, the target processing graphic element moved to the alignment reference object cannot be accurately moved to the target position where the target processing graphic element is required to be aligned. Adjusting the position of the target processing graphic element one by one at the alignment reference object requires a large amount of work, and the arrangement efficiency is low.

In the field of laser applications, the processing region and objects of the equipment will be mapped in the software. Laser equipment generally maps the processing region through a camera or obtains the calibrated position of the laser tip through an encoder, and generates the calibrated region in the software. In order to solve the problems that during the arrangement process of the existing scheme for arranging the regional element, the target processing graphic element cannot be accurately adsorbed to the target position on the alignment reference object such as the processing region, it is inconvenient to adjust the setting position of the target processing graphic element, and the arrangement efficiency is low.

As shown in FIG. 1 to FIG. 14, the present application provides a method and a device for arranging the regional element, a machine, a system, a storage medium and a product. The device can be used to arrange a regional element for realizing regional element arrangement. The device for arranging a regional element includes a host computer, or includes a host computer and a computer numerical control machine. The machine is mainly but not limited to computer numerical control equipment, such as the laser cutting equipment, the laser engraving equipment, the knife cutting processing equipment, and the like. The storage medium is a computer-readable storage medium, and the product is a computer program product. The system includes at least one data processor and at least one computer-readable medium, and the computer-readable medium is defined as the non-transitory computer-readable medium in this application. The non-transitory computer-readable medium includes a storage space located in a single physical storage device or a storage space distributed across a plurality of physical storage devices. The program instructions stored on the non-transitory computer-readable medium can be executed by at least one data processor, so that the system is configured to implement the method for arranging the regional element as described below.

As shown in FIG. 1, FIG. 1 schematically shows a schematic diagram of a system architecture 100 to which the technical solutions of the present application are applied to. The system architecture 100 may include a terminal device 110, a network 120, and a server 130. The terminal device 110 may include a smart phone, a tablet computer, a laptop computer, an intelligent voice interaction device, a processing device such as a laser processing device, and the like. The server 130 may be an independent physical server, or a server cluster or a distributed system composed of a plurality of physical servers, or a cloud server providing cloud computing services. The network 120 may be a communication medium of various connection types that can provide a communication link between the terminal device 110 and the server 130, for example, a wired communication link or a wireless communication link. According to the implementation requirements, the system architecture 100 in the embodiment of the present application may have any number of terminal devices 110, networks 120, and servers 130.

The technical solution provided in the embodiment of the present application may be applied to the terminal device 110, or to the server 130, or may be implemented jointly by the terminal device 110 and the server 130, which will not be limited in the present application. For example, the terminal device 110 is a processing device, such as a laser cutting device, a laser engraving device, or a knife cutting processing device, and the server 130 is a server corresponding to the processing device. The technical solution of the present application may be implemented by the processing device, or by the server corresponding to the processing device, or by the processing device and the corresponding server.

The technical solution of the present application may be applied, but is not limited, to a scenario for arranging a regional element that is used for aligning the position of the target processing graphic element with the alignment reference object through laser processing such as laser cutting and laser engraving, or may be applied to a scenario for arranging a regional element that is used for aligning the position of the target processing graphic element with the alignment reference object through knife cutting processing. The technical solution of the present application is used to accurately process the target processing graphic element at the position required to be aligned when the laser beam is used to cut, weld, or perform surface treatment on a material, or when a tool is used to cut, perform surface treatment on a material.

Some technical solutions of embodiments of the present application may be implemented based on the system architecture 100 shown in FIG. 1 or its variant system architecture, and the method for arranging the regional element may be applicable to the system architecture shown in FIG. 1 or other system architectures, which are not limited here.

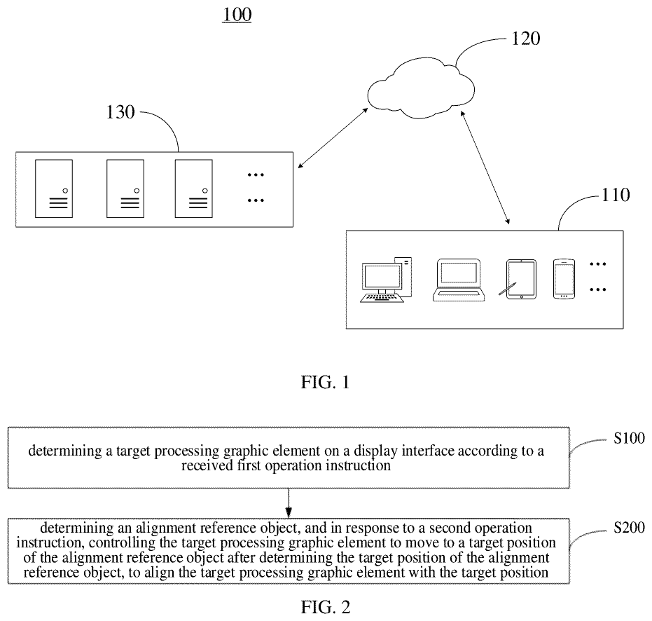

As shown in FIG. 2, the method for arranging the regional element includes the following steps.

Step S100, determining a target processing graphic element on a display interface according to a received first operation instruction.

It can be understood that, in an embodiment, according to the received first operation instruction, the target processing graphic element can be determined from at least one processing graphic element displayed on the display interface. Or, in response to the received first operation instruction, the processing graphic element can be created on the display interface, and the created processing graphic element can be determined as the target processing graphic element. Or, at least one of the created multiple processing graphic elements can be determined as the target processing graphic element. The display interface display will display processing regions such as the canvas, the calibrated processing region, the curved surface processing region, and the like. The canvas corresponds to the calibrable range of the processing tip, and the calibrated processing region, the curved surface processing region, etc. correspond to the processing region actually calibrated through the processing tip. By completing the element arrangement on the canvas or the calibrated processing region of the display interface, the element arrangement of the actual processing region can be further completed.

Step S200, determining an alignment reference object, and in response to a second operation instruction, controlling the target processing graphic element to move to a target position of the alignment reference object after determining the target position of the alignment reference object, to align the target processing graphic element with the target position, the second operation instruction being configured to specify a target position to be aligned of the target processing graphic element.

The alignment reference object may be, but is not limited to, a canvas, a calibrated processing region, a curved surface processing region, an auxiliary line. It may also be a processing tip calibration position such as a laser tip calibration point and other calibration points. Determining the alignment reference object, and in response to the second operation instruction, determining the alignment reference object and responding to the second operation instruction can be implemented simultaneously or successively, which may be set according to the actual requirements and will not be limited here.

As for the operation of responding to the second operation instruction, it can be, but is not limited to, responding to a movement trigger instruction such as a dragging operation on the target processing graphic element. Or, a smart adsorption switch, an operation button, and the like, are provided as trigger control members at the canvas, the setting position, the operation bar, and the like of the display interface. In response to the trigger instruction of these trigger control members, the trigger control members can be further refined into a first interactive control member, a second interactive control member, a third interactive control member, a moving object interactive control member, and the like according to the different positions, triggering methods, functions, and alignment methods set on the display interface, so as to realize functions such as movement, adsorption, and alignment. The target position with which the target processing graphic element is aligned will be specified through dragging adsorption, button triggering, smart adsorption switch, and the like, so that the target processing graphic element is controlled to move to the corresponding target position. In the embodiment of the present application, after determining the target processing graphic element on the display interface and determining the target position of the alignment reference object, the position of the target processing graphic element in the actual processing region can be accurately specified by controlling the target processing graphic element to move to the target position, which is convenient for adjustment and can effectively solve the problem of low arrangement efficiency. In this way, the adjustment of the arrangement position of the target processing graphic element can be performed more flexibly, which can not only meet the arrangement requirements of elements in different regions and optimize the user experience, but also can avoid affecting the arrangement effect due to the inability to accurately specify the position of the target processing graphic element in the alignment reference object.

It should be noted that in the embodiment of the present application, the alignment reference object includes at least one of the following: the canvas, the calibrated processing region, the curved surface processing region, and the auxiliary line.

When the alignment reference object is a calibrated processing region, the determining the alignment reference object includes: generating a calibrated processing region corresponding to the actual processing region on a canvas of a display interface based on an actual processing region calibrated by a processing tip, and determining the generated calibrated processing region as the alignment reference object.

In an embodiment, one or a plurality of actual processing regions may be calibrated by a processing tip such as a laser tip, and a corresponding calibrated processing region may be generated on a canvas or other position of a display interface corresponding to each calibrated actual processing region.

When the alignment reference object is an auxiliary line, a plurality of target positions are generated on the auxiliary line. The plurality of target positions may be arranged along the length direction of the auxiliary line, or the plurality of target positions may be arranged regularly or irregularly in a sub-region form such as a grid corresponding to the position of the auxiliary line. At least part of the generated plurality of target positions is set in the calibrated processing region or other positions of the display interface. When the alignment reference object is a calibrated processing region, taking the actual processing region in a rectangular shape as an example, in an embodiment, the actual processing region in a rectangular shape includes two groups of bending points, and each group of bending points includes two bending points set opposite to each other. The positions of the two bending points in any group of the two groups of bending points are determined through the processing tip, that is, the position coordinates and other position parameters of each point in the actual processing region are determined by the processing tip, so as to generate a calibrated processing region of corresponding size at a corresponding position on the canvas of the display interface, and determine the generated calibrated processing region as the alignment reference object. In an embodiment, the actual processing region can also be set to a combination shape of a circle, an ellipse, a triangle or other regular or irregular shapes according to actual conditions, and the calibration position and calibration method are determined according to the specific shape of the actual processing region, which is not limited here. When the actual processing region is a curved surface, the alignment reference object is a curved surface processing region, and the implementation methods of other alignment reference objects refer to the above embodiments, which will not be repeated here.

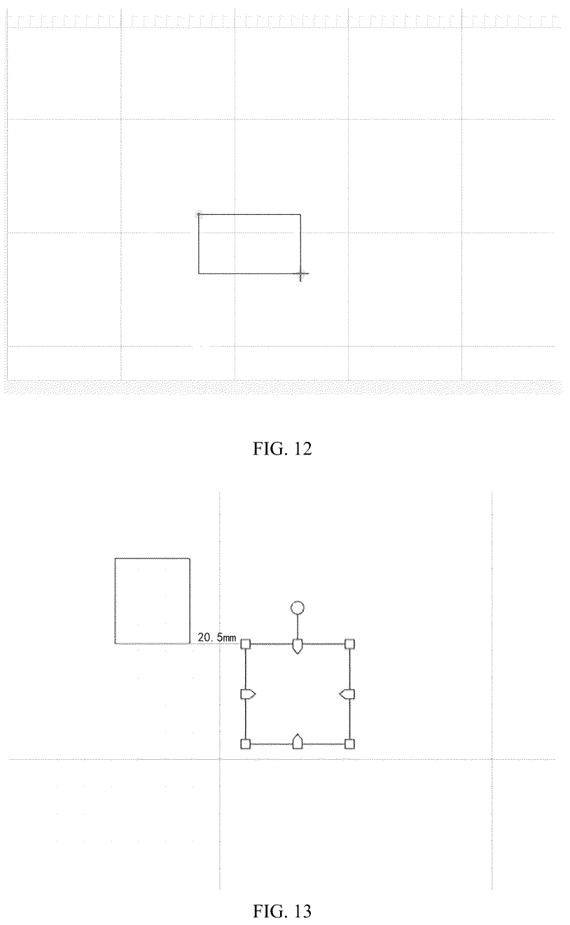

Taking the alignment reference object as the calibrated processing region as an example, as shown in FIG. 12, the corresponding nodes and other alignment positions can be highlighted on the display interface with a cross mark, a dot, and the like according to the calibrated nodes (such as the bending point of the actual processing region) and other positions. During the calibration process, the position coordinates and other position parameters corresponding to the node can be displayed by clicking the generated node on the display interface. In an embodiment, the actual processing region calibrated by the processing tip can be obtained according to the position of the processing region obtained when the processing tip is moved, and after the calibrated processing region corresponding to the actual processing region is generated on the canvas of the display interface, the corresponding node can be highlighted and the position coordinates and other position parameters corresponding to the node can be displayed by clicking the nodes and other alignment positions (such as the bending point, the center point, and the like) of the generated calibrated processing region on the canvas of the display interface. The specific settings can be based on the actual requirements, which will not be repeated here.

In an embodiment, there may be one or a plurality of alignment reference objects displayed on the display interface, and there may be one or a plurality of processing graphic elements displayed on the display interface. In an embodiment, the alignment reference objects may be responsive to a trigger instruction such as a click trigger instruction on the processing graphic element displayed on the display interface, so as to determine a selected processing graphic element according to the trigger instruction, and determine the selected processing graphic element as a target processing graphic element. Or, all processing graphic elements displayed on the display interface are directly determined as target processing graphic elements. If there are a plurality of target processing graphic elements, when executing step S200, after determining the target position of any target processing graphic element, the target processing graphic element can be controlled to move to the corresponding target position until the position designation of all target processing graphic elements is completed. Or, after determining the target position of each target processing graphic element, each target processing graphic element can be controlled to move to the corresponding target position simultaneously. Or, a target position can be specified and a plurality of target processing graphic elements can be controlled to move to the target position simultaneously. When there are a plurality of target processing graphic elements, the sizes, graphics, and the like of the plurality of target processing graphic elements can be the same or different, which can be set according to the actual situation and will not be described in detail here.

In an embodiment, the alignment reference object also includes at least one of the following: processing tip calibration position, alternative calibration position, etc. or reference point. In an embodiment, the processing spot of the processing tip can be displayed in the display interface in the form of a cross mark, etc., and the implementation of other calibration positions, reference points, etc. as alignment reference objects can refer to the above embodiments, and will not be repeated here.

Further, after the controlling the target processing graphic element to move to a target position of the alignment reference object after determining the target position of the alignment reference object, to align the target processing graphic element with the target position, the method further includes:
in response to a third operation instruction, determining a position of the target processing graphic element on the alignment reference object, and generating a scheme for arranging the regional element. The generated scheme for arranging the regional element can be, but not limited to, a processing file in gcode format or any other format, which is used to complete the processing for the corresponding target processing graphic element at each target position according to the generated scheme for arranging the regional element, so as to realize the global planning of the target processing graphic element and improve the processing efficiency.

In some embodiments of the present application, the step of in response to the second operation instruction includes responding to the second operation instruction, to realize the moving adsorption or automatic adsorption of the target processing graphic element.

As an example, responding to the second operation instruction includes responding to the movement trigger instruction such as clicking, dragging, and moving, to move the target processing graphic element when performing dragging, and moving adsorption.

Taking the moving target processing graphic element by dragging as an example, the distance between the target position and the target processing graphic element is continuously obtained during the dragging and moving process of the target processing graphic element. When the distance between the target position and the target processing graphic element is less than or equal to the adsorption distance, the adsorption operation is realized to control the target processing graphic element to move to the target position.

The second operation instruction includes a movement trigger instruction. When controlling the target processing graphic element to move to the target position of the alignment reference object, the number of target positions of the alignment reference object set in the calibrated processing region needs to be considered, and there is one or a plurality of target positions.

As an example, when the alignment reference object is a calibrated processing region with one or a plurality of processing regions and alignment positions, and there is one target position within the adsorption distance between the target processing graphic element and the alignment reference object, the step of in response to the second operation instruction, controlling the target processing graphic element to move to the target position of the alignment reference object after determining the target position of the alignment reference object includes:
in response to the movement trigger instruction of the target processing graphic element, when a distance between the target processing graphic element and a target position of the alignment reference object is within the adsorption distance, controlling the target processing graphic element to move to the target position of the alignment reference object.

When there is one target position, the target processing graphic element moves to the target position during the process of dragging the target processing graphic element. When the distance between the target position and the target processing graphic element is less than or equal to the adsorption distance, the automatic adsorption is implemented to control the target processing graphic element to move to the target position. The target position can be the center of the alignment reference object or any other position of the alignment reference object, which is not limited here.

As a second embodiment, when the alignment reference object is a calibrated processing region or other processing region with one or more alignment positions, auxiliary lines, and there are a plurality of target positions within the adsorption distance between the target processing graphic element and the alignment reference object, the step of in response to the second operation instruction, controlling the target processing graphic element to move to the target position of the alignment reference object after determining the target position of the alignment reference object includes:
in response to the movement trigger instruction of the target processing graphic element, when a distance between the target processing graphic element and a plurality of target positions of the alignment reference object is within the adsorption distance, controlling the target processing graphic element to move to the target position closest to the target processing graphic element.

When there are a plurality of target positions, the plurality of target positions may be any position of the alignment reference object, such as the center of the alignment reference object. In response to the movement trigger instruction of the target processing graphic element, the distances between the plurality of target positions and the target processing graphic element are continuously acquired during the process of dragging and moving the target processing graphic element, so as to obtain the distances between each target position and the target processing graphic element, and the smallest distance of the plurality of distances, namely the target position corresponding to the smallest distance, is used as the target processing region. When the distance between the target position and the target processing graphic element is less than or equal to the adsorption distance, the automatic adsorption is implemented to control the target processing graphic element to move to the target position.

Further, in order to solve the problem that the spatial relationship such as the distance between the target processing graphic element and the target position cannot be known during the dragging and moving process of the target processing graphic element, after receiving the movement trigger instruction of the target processing graphic element, the distance between a plurality of target positions and the target processing graphic element is continuously obtained during the dragging and moving process of the target processing graphic element, so as to obtain and display the first distance between each target position and the target processing graphic element. The first distance can be displayed through a pop-up window, a status bar, and the like. Or the value corresponding to the first distance can be directly displayed between the target processing position and the target processing graphic element, so as to display and remind the user in real time the distance between the target processing graphic element and the target position. In addition, according to actual conditions, the moving path of the target processing graphic element, the identification line of the minimum moving path from the target processing graphic element to each target position, and the like can also be displayed in real time during the dragging and moving process of the target processing graphic element. The specific settings can be made according to actual conditions, and will not be repeated here.

It can be understood that the aforementioned adsorption distance can be no greater than the distance between two adjacent target positions or other distance values, which can be set according to actual conditions and is not limited here.

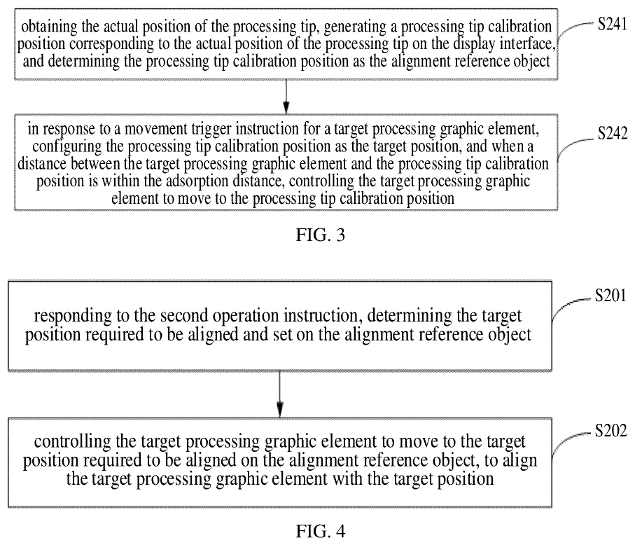

As shown in FIG. 3, in a third embodiment, when the alignment reference object is a processing tip calibration position, such as a laser tip calibration position or other calibration position or reference point, the second operation instruction includes a movement trigger instruction, and the step S200, determining the alignment reference object, and in response to the second operation instruction, controlling the target processing graphic element to move to the target position of the alignment reference object after determining the target position of the alignment reference object includes:

step S241, obtaining the actual position of the processing tip, generating a processing tip calibration position corresponding to the actual position of the processing tip on the display interface, and determining the processing tip calibration position as the alignment reference object.

A processing tip calibration position corresponding to the actual position of a processing tip of a laser tip, a knife cutting tip, a cutting tip, a pen tip, a drill tip, and the like is generated on the display interface, and will be displayed with a cross mark, a dot, and the like. The processing tip calibration position is determined as an alignment reference object, which will be used as the target position.

Step S242, in response to a movement trigger instruction for a target processing graphic element, configuring the processing tip calibration position as the target position, and when a distance between the target processing graphic element and the processing tip calibration position is within the adsorption distance, controlling the target processing graphic element to move to the processing tip calibration position.

The processing tip calibration position is used as the target position, and during a process of dragging and moving the target processing graphic element, when the target processing graphic element is dragged and moved towards the processing tip calibration position and the distance between the target processing graphic element and the processing tip calibration position is less than or equal to the adsorption distance, the automatic adsorption is implemented to control the target processing graphic element to move to the target position.

It should be noted that the aforementioned step S241 can be performed before determining the target processing graphic element, that is, the processing tip calibration position will be generated on the display interface in advance. Or, the aforementioned step S241 of generating the processing tip calibration position on the display interface is performed after determining the target processing graphic element, which is not limited here.

In some other embodiments of the present application, the processing tip calibration position is replaced by a reference point such as an alternative calibration position at any position displayed on the display interface. The implementation method of generating other alternative calibration positions on the display interface refers to the aforementioned embodiments of the processing tip calibration position, which is not described here one by one.

In another embodiment, responding to the second operation instruction includes responding to the trigger instruction of the intelligent adsorption switch, operation button, and the like of the canvas, setting position, operation bar on the display interface, to realize the automatic adsorption of the target processing graphic element.

In an embodiment, the display interface displays a second interactive control member, and the second operation instruction includes a trigger instruction for the second interactive control member. In step S200, in response to the second operation instruction, controlling the target processing graphic element to move to the target position of the alignment reference object after determining the target position of the alignment reference object includes:
in response to the trigger instruction of the second interactive control member, when a distance between the target processing graphic element and a target position of the alignment reference object is within the adsorption distance, controlling the target processing graphic element to move to the target position of the alignment reference object.

It can be understood that when there is one target position, in response to the trigger instruction of the second interactive control member, when the distance between the target position and the target processing graphic element is less than or equal to the adsorption distance, the target processing graphic element automatically moves to the target position to realize the automatic adsorption, so as to control the target processing graphic element to automatically move to the target position, and the target position can be the center of the alignment reference object or any other position of the alignment reference object, which is not limited here.

It should be noted that when there is one target position, in response to the trigger instruction of the second interactive control member, when the distance between the target processing graphic element and a target position of the alignment reference object is within the adsorption distance, the target processing graphic element is controlled to move to the target position of the alignment reference object, so as to avoid moving the target processing graphic element to other moving objects except the alignment reference object, thereby realizing accurate positioning and improving the reliability of automatic adsorption. To avoid limiting the embodiments of the present application, in some other alternative embodiments of the present application, in response to the trigger instruction of the second interactive control member, when there is one target position, the target processing graphic element automatically moves to the target position, without judging whether the distance between the target processing graphic element and a target position of the alignment reference object is within the adsorption distance, so as to control the target processing graphic element to move to the target position of the alignment reference object, which can be set based on actual conditions and will not be limited here.

Or, in response to the trigger instruction of the second interactive control member, when the distance between the target processing graphic element and a plurality of target positions of the alignment reference object is within the adsorption distance, the target processing graphic element is controlled to move to the target position closest to the target processing graphic element.

It can be understood that when there are a plurality of target positions, the plurality of target positions can be located at the center of the alignment reference object or any other position of the alignment reference object. In response to the trigger instruction of the second interactive control member, when the distance between the plurality of target positions and the target processing graphic element is less than or equal to the adsorption distance, the target position closest to the target processing graphic element among the plurality of target positions is determined as the target position that the target processing graphic element is aligned with, and the target processing graphic element is controlled to move to the target position closest to the target processing graphic element, so as to realize the automatic adsorption and control the target processing graphic element to automatically move to the target position closest to the distance, thereby realizing accurate positioning and improving the reliability of automatic adsorption.

In order to realize the moving adsorption or automatic adsorption of the target processing graphic element and help the user determine the target position and the distance between the target processing graphic element and the target position, before the step S200 of in response to the second operation instruction, controlling the target processing graphic element to move to the target position of the alignment reference object after determining the target position of the alignment reference object, to align the target processing graphic element with the target position, the method further includes:
in response to the movement trigger instruction for the target processing graphic element, when a distance between the target processing graphic element and one or a plurality of target positions is within the adsorption distance, highlighting the target position.

When a distance between the target processing graphic element and one or a plurality of target positions is within the adsorption distance, that is, when the distance between the target processing graphic element and the target processing graphic element is less than or equal to the adsorption distance, the target position is highlighted. Taking the alignment reference object as the processing tip calibration position, the alternative calibration position, the other calibration position or the reference point as an example, the processing tip calibration position, the alternative calibration position, the other calibration position or the reference point are highlighted. Taking the alignment reference object as the calibrated processing region as an example, the highlighted target position includes an identification line for highlighting the calibrated processing region, and the identification line includes at least one of a first boundary line extending in the vertical direction of the calibrated processing region, a second boundary line extending in the horizontal direction of the calibrated processing region, an intersection point of the first boundary line and the second boundary line, and a center of the calibrated processing region. When the calibrated processing region has a plurality of sub-regions, the highlighted target position may also include a sub-region and a boundary line of the sub-region. In other embodiments of the present application, when the distance between the target processing graphic element and one or more of the plurality of target positions is within the adsorption distance, the calibrated processing region and the boundary line of the calibrated processing region may also be highlighted, which may be set according to actual conditions and is not limited here.

As shown in FIG. 4, in some other embodiments of the present application, the responding to the second operation instruction includes responding to trigger instructions of intelligent adsorption switches, operation buttons, and the like displayed on the canvas, setting position, operation bar of the display interface, to achieve automatic movement and alignment of the target processing graphic element. In step S200, in response to a second operation instruction, controlling the target processing graphic element to move to a target position of the alignment reference object after determining the target position of the alignment reference object, to align the target processing graphic element with the target position, where the second operation instruction is configured to specify a target position to be aligned of the target processing graphic element includes:

step S201, responding to the second operation instruction, determining the target position required to be aligned and set on the alignment reference object.

In an embodiment, the canvas, the setting position, the operation bar and other positions of the display interface are provided with intelligent adsorption switches, operation buttons and the like as operation control members. Step S201 is mainly used to respond to the second operation instruction of the operation portion such as the operation control member, so as to specify the target position of the target processing graphic element to be aligned and set.

Step S202, controlling the target processing graphic element to move to the target position required to be aligned on the alignment reference object, so as to align the target processing graphic element with the target position.

Any moving object used to specify the display interface, such as the canvas, the calibrated processing region, the curved surface processing region, the auxiliary line, processing tip calibration position, is configured as the alignment reference object, and the target processing graphic element is moved to achieve alignment between the target processing graphic element and the alignment reference object at any position.

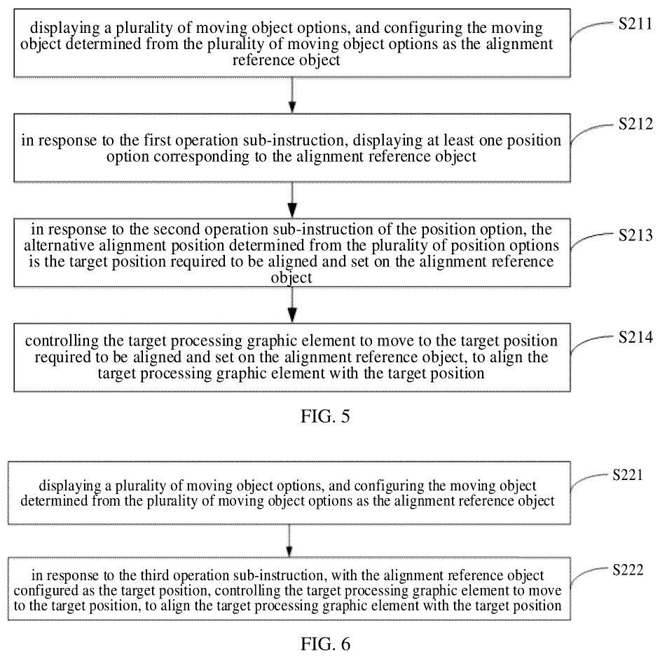

As shown in FIG. 5, in an embodiment, when the moving object is one of a calibrated processing region, a curved surface processing region, an auxiliary line, and the like. which may have one or a plurality of alignment positions, and when the target processing graphic element is aligned with one of the plurality of alignment positions, the second operation instruction includes a first operation sub-instruction and a second operation sub-instruction, and the step S200, determining an alignment reference object, and in response to a second operation instruction, controlling the target processing graphic element to move to a target position of the alignment reference object after determining the target position of the alignment reference object, to align the target processing graphic element with the target position includes:

step S211, displaying a plurality of moving object options, and configuring the moving object determined from the plurality of moving object options as the alignment reference object, where each moving object option corresponds to a moving object displayed on the display interface, and the moving object includes a canvas, a calibrated processing region, a curved surface processing region, and an auxiliary line.

In an embodiment, the display interface displays a moving object interactive control member, and in response to a trigger instruction to the moving object interactive control member, a plurality of moving object options such as the “canvas”, the “calibrated processing region”, the “curved surface processing region”, and the “auxiliary line” are displayed in the form of a menu, a list, and the like. The moving object selected from the plurality of moving object options is determined according to the trigger instruction, and the selected moving object is determined as the alignment reference object. It should be noted that, according to actual conditions, other moving objects suitable for actual processing can also be used as alignment reference objects, which are not repeated here.

Step S212, in response to the first operation sub-instruction, displaying at least one position option corresponding to the alignment reference object, where each position option corresponds to an alternative alignment position on the alignment reference object.

In an embodiment, a plurality of moving objects are displayed through the expanded first-level menu, and the selected moving object is determined as the alignment reference object according to the trigger instruction of the moving object interactive control member, and at least one position option corresponding to the alternative alignment position of the alignment reference object is displayed through the expanded secondary menu.

Step S213, in response to the second operation sub-instruction of the position option, the alternative alignment position determined from the plurality of position options is the target position required to be aligned and set on the alignment reference object.

In an embodiment, the alignment reference object is provided with at least one alternative alignment position, which can be set by a user when creating a moving object, or can be automatically set by a host computer according to the size, the coordinate position, etc. of the moving object when downloading or creating the moving object, or can be set by a user or a host computer according to the correspondence between the position and the size of a target processing graphic element and the alignment reference object. In an embodiment, the alternative alignment position of the alignment reference object and other alignment positions can be set according to actual conditions, which is not limited herein. When the expanded secondary menu displays an alternative alignment position corresponding to the alignment reference object, in response to a trigger instruction for the alternative alignment position, the alternative alignment position is determined as the target position required to be aligned and set on the alignment reference object. When the expanded secondary menu displays a plurality of alternative alignment positions corresponding to the alignment reference object, in response to a trigger instruction for any one of the plurality of alternative alignment positions, the selected alternative alignment position is determined as the target position required to be aligned and set on the alignment reference object.

Step S214, controlling the target processing graphic element to move to the target position required to be aligned and set on the alignment reference object, so that the target processing graphic element is aligned with the target position. In this way, the alignment between the target processing graphic element with any target position on the alignment reference object can be achieved.

In an embodiment, according to the received trigger instruction such as a click operation, the target processing graphic element is directly controlled to move to the target position. In response to the second operation sub-instruction such as the click trigger of the position option, the target processing graphic element is directly controlled to move to the target position required to be aligned and set on the alignment reference object after determining the selected alternative alignment position according to the second operation sub-instruction, and after determining the selected alternative alignment position as the target position required to be aligned and set on the alignment reference object, so that the target processing graphic element is aligned with the target position. Or, according to the second operation sub-instruction, the selected alternative alignment position is determined as the target position required to be aligned and set on the alignment reference object, and after receiving the determination instruction, the target processing graphic element is controlled to move to the target position required to be aligned and set on the alignment reference object, so that the target processing graphic element is aligned with the target position.

According to FIG. 6, in another embodiment, when the moving object is a processing tip calibration position such as a laser tip calibration position or other marking position, and the moving object is used as a marking point or reference point of the target position, the second operation instruction includes a third operation sub-instruction. The step S200, determining an alignment reference object, and in response to a second operation instruction, controlling the target processing graphic element to move to a target position of the alignment reference object after determining the target position of the alignment reference object, to align the target processing graphic element with the target position, includes:

step S221, displaying a plurality of moving object options, and configuring the moving object determined from the plurality of moving object options as the alignment reference object, where each moving object option corresponds to a moving object displayed on the display interface, and the moving object includes a processing tip calibration position, and an alternative calibration point.

In an embodiment, the display interface displays a moving object interactive control member, and in response to a trigger instruction for the moving object interactive control member, the processing tip calibration position such as “laser tip calibration position” and other alternative calibration point for a plurality of moving object options are displayed in the form of a menu, a list, and the like. A moving object selected from a plurality of moving object options is determined according to the trigger instruction, and the selected moving object is determined as the alignment reference object. It should be noted that, according to actual conditions, other moving objects suitable for actual processing can also be used as alignment reference objects. The laser tip calibration position and the moving object are used as the calibration point or reference point of the target position, and the moving objects that can have one or more alignment positions such as the calibrated processing region in the aforementioned embodiment are merged into the same menu or list, which can be set according to actual conditions and will not be repeated here.

Step S222, in response to the third operation sub-instruction, with the alignment reference object configured as the target position, controlling the target processing graphic element to move to the target position, so that the target processing graphic element is aligned with the target position.

In an embodiment, the processing tip calibration position, the alternative calibration point, etc. displayed in the expanded first-level menu are used as moving objects, any moving object is determined as the alignment reference object, the alignment reference object is determined as the target position, and the target processing graphic element is controlled to move to the position where the alignment reference object is located, so that the target processing graphic element is aligned with the processing tip calibration position such as the alignment reference object. Or, any moving object is determined as the alignment reference object, and the alignment reference object is determined as the target position, and after receiving the determination instruction, the target processing graphic element is controlled to move to the position where the alignment reference object is located, so that the target processing graphic element is aligned with the alignment reference object selected by the processing tip calibration position.

Further, the target position of the aforementioned embodiment can be a reference point, a reference line or other reference object on the moving object provided on the display interface, or can be the nine-grid, twelve-grid, sixteen-grid, twenty-grid or the like which is divided into a plurality of sub-regions on the moving object such as the calibrated processing region, and the target position is designated as one of the plurality of sub-regions, such as the grids, or the target position is designated as a corresponding boundary point on the plurality of sub-regions, such as the grids. If the target position is a reference point, a reference line or other reference object, when the distance between the target position and the target processing graphic element is less than or equal to the adsorption distance, the target position is highlighted. If the target position is a sub-region such as a grid, when the distance between the target position and the target processing graphic element is less than or equal to the adsorption distance, the identification line of the sub-region or the corresponding boundary point is highlighted, and the identification line of the sub-region includes at least one of the first boundary line extending in the vertical direction of the sub-region, the second boundary line extending in the horizontal direction of the sub-region, the intersection point of the first boundary line and the second boundary line, and the center of the sub-region.

As a specific embodiment, the calibrated processing region is provided with a plurality of target positions. The plurality of target positions include positions corresponding to nine boundary points, namely, the center of the calibrated processing region, the upper left corner of the calibrated processing region, the lower left corner of the calibrated processing region, the upper right corner of the calibrated processing region, the lower right corner of the calibrated processing region, the middle of the left side of the calibrated processing region, the middle of the right side of the calibrated processing region, the middle of the top of the calibrated processing region, and the middle of the bottom of the calibrated processing region. In an embodiment, a point P (x, y) on the target processing graphic element can be designated as the alignment anchor point, so as to obtain the distance between P (x, y) and the plurality of target positions of the calibrated processing region in the adsorption process, so as to determine the distance between the target processing graphic element and the plurality of target positions of the alignment reference object and obtain a plurality of first distances. In this way, the target processing graphic element can be controlled to move to the target position closest to the target processing graphic element when realizing dragging-and-dropping adsorption and automatic adsorption.

In an embodiment, the target position can be a reference point, a reference line or other reference object on a moving object provided on a display interface, or it can also be a nine-grid, twelve-grid, sixteen-grid, twenty-grid or the like having a plurality of sub-regions divided on a moving object such as a calibrated processing region, and the target position is designated as one of the plurality of sub-regions, such as the grids, or the target position is designated as a corresponding boundary point on the plurality of sub-regions such as the grids.

As shown in FIG. 7, in another embodiment, the calibrated processing region can be divided into the alignment reference object having a plurality of sub-regions, the display interface displays a first interactive control member. The second operation instruction includes a fourth operation sub-instruction and a fifth operation sub-instruction. The step S200, in response to a second operation instruction, controlling the target processing graphic element to move to a target position of the alignment reference object after determining the target position of the alignment reference object, to align the target processing graphic element with the target position includes:

step S231, in response to the fourth operation sub-instruction of the first interactive control member, displaying a plurality of position options on the display interface, each position option corresponding to one sub-region on the alignment reference object.

A plurality of position options corresponding to a plurality of sub-regions of the alignment reference object are displayed on the display interface, the plurality of position options are displayed in the form of menus, lists, interactive buttons, and the like for determining a sub-region selected from the plurality of position options as a target position.

Step S232, in response to the fifth operation sub-instruction of the position option, the sub-region determined from the plurality of position options is the target position, and the target processing graphic element is controlled to move to the target position, so that the target processing graphic element is aligned with the target position.

In an embodiment, the alignment reference object is provided with at least one sub-region, and the sub-region configured as the alternative alignment position can be set by the user when creating the moving object, or can be automatically set by the host computer according to the size, coordinate position, etc. of the moving object when downloading or creating the moving object, or can be set by the user or the host computer according to the corresponding relationship between the position and size of the target processing graphic element and the alignment reference object. In an embodiment, the alternative alignment position of the alignment reference object can be set according to the actual situation, which is not limited here.

The sub-region determined according to the fifth operation sub-instruction configured as the selected sub-region, when the target processing graphic element is controlled to move to the selected sub-region, by controlling the target processing graphic element to align and overlap with the selected sub-region, the alignment between the target processing graphic element and the target position can be realized, and the positioning accuracy can be optimized.

In an embodiment, the alignment reference object is a calibrated processing region, and the sub-region is a divided grid. Based on this, in an embodiment, an alignment anchor point can be set on the target graphic element, so that when the target processing graphic element is controlled to move to the corresponding sub-region, the alignment anchor point is controlled to align and overlap with the center, the bending angle, the corresponding boundary point, and the like of the selected sub-region, to achieve the alignment between the target processing graphic element and the target position.

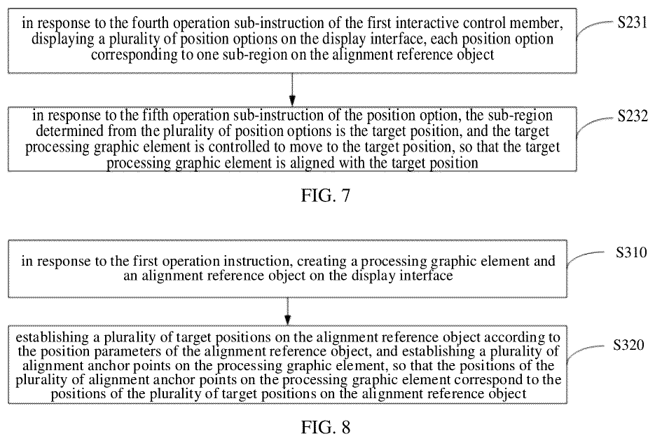

As shown in FIG. 8, in an embodiment, the method for arranging the regional element further includes:

step S310, in response to the first operation instruction, creating a processing graphic element and an alignment reference object on the display interface.

In an embodiment, in response to the first operation instruction, the processing graphic element can be created by providing an element library including multiple processing graphic elements, and in response to the first operation instruction, the processing graphic element selected or set from the element library can be created and displayed on the display interface. In response to the first operation instruction, the alignment reference object can be created by providing a material library including multiple moving objects, and in response to the first operation instruction, the moving object selected or set from the material library can be created and displayed on the display interface as the alignment reference object. Or, based on the actual processing region calibrated by the processing tip, the alignment reference object can be created by generating a calibrated processing region corresponding to the actual processing region on the canvas of the display interface.

Step S320, establishing a plurality of target positions on the alignment reference object according to the position parameters of the alignment reference object, and establishing a plurality of alignment anchor points on the processing graphic element, so that the positions of the plurality of alignment anchor points on the processing graphic element correspond to the positions of the plurality of target positions on the alignment reference object.

The execution order of the above steps can be performed sequentially or in no particular order, that is, while creating the processing graphic element and the alignment reference object, establishing a plurality of target positions on the alignment reference object, and establishing a plurality of alignment anchor points on the processing graphic element. Or after creating the processing graphic element and the alignment reference object, establishing a plurality of target positions on the alignment reference object, and establishing a plurality of alignment anchor points on the processing graphic element. The position parameters of the alignment reference object and the alignment positions such as a plurality of target positions established on the alignment reference object according to the position parameters can be preset or set or updated according to the received setting instructions during the processing.

When the alignment reference object is a calibrated processing region, an actual processing region calibrated by a laser tip is obtained, and after a calibrated processing region corresponding to the actual processing region is generated on a display interface. Then, according to position parameters such as position coordinates of each point in the actual processing region, a plurality of target positions are established on the alignment reference object. The plurality of target positions include positions corresponding to nine boundary points, namely, a center of the calibrated processing region, an upper left corner of the calibrated processing region, a lower left corner of the calibrated processing region, an upper right corner of the calibrated processing region, a lower right corner of the calibrated processing region, a middle of the left side of the calibrated processing region, a middle of the right side of the calibrated processing region, a middle of the top of the calibrated processing region, and a middle of the bottom of the calibrated processing region, so as to divide the calibrated processing region into nine sub-regions in a nine-square grid shape. The graphic parameters of the target processing graphic element and the plurality of alignment anchor points determined on the target processing graphic element according to the graphic parameters can be preset or set or updated according to the received setting instructions during the processing process. The positions of the plurality of alignment anchor points on the target processing graphic element correspond to the positions of the plurality of target positions on the alignment reference object, so that the target processing graphic element on the display interface is controlled to move to the target position of the calibrated processing region. In an embodiment, when the upper left corner of the calibrated processing region is designated as the target position, the upper left corner of the target processing graphic element is controlled to be aligned and overlapped with the upper left corner of the calibrated processing region. When the middle of the right side of the calibrated processing region is designated as the target position, the middle of the right side of the target processing graphic element is controlled to be aligned and overlapped with the middle of the right side of the calibrated processing region. The specific settings can be based on actual conditions, which will not be described in detail here.

It should be noted that the canvas displayed on the display interface corresponds to the calibrated range of the processing tip, such as the laser tip, and the calibrated processing region corresponds to the actual processing region. In the actual processing process, it is inevitable that there will be another target processing graphic element arranged outside the actual processing region calibrated by the laser tip, and the moving object arranged outside the calibrated processing region is provided with a plurality of target positions in the calibrated processing region. Therefore, when determining the target position, other alignment reference objects arranged outside the actual processing region also need to be considered.

The method for arranging the regional element in the embodiment of the present application can not only manually drag the target processing graphic element to move the target processing graphic element to the target position, but also be compatible with intelligent adsorption switches, operation buttons and other operating portions to select the moving object and/or the target position. In step S200, in response to a second operation instruction, controlling the target processing graphic element to move to a target position of the alignment reference object after determining the target position of the alignment reference object, to align the target processing graphic element with the target position includes:
in response to the second operation instruction, the corresponding alignment anchor point on the target processing graphic element is determined according to the target position determined through the second operation instruction, and the target processing graphic element is controlled to move, so that the corresponding alignment anchor point on the target processing graphic element is aligned and overlapped with the determined target position.

By specifying the target position on the alignment reference object, the target processing graphic element is automatically moved to the alignment reference object, and is aligned and overlapped with the selected target position set on the alignment reference object. When a plurality of target processing graphic elements are displayed on the display interface, the plurality of target processing graphic elements can be designated one by one, and after each designation, the corresponding target position can be selected to control the plurality of target processing graphic elements to move to the corresponding target position. Or after designating the plurality of target processing graphic elements, the plurality of target processing graphic elements can be controlled to move to the target position corresponding to the calibrated processing region simultaneously.

The alignment reference object as the calibrated processing region and the processing region is provided with one or more alignment positions, auxiliary lines, and the like. The method for arranging the regional element in the embodiment of the present application can be implemented in the following manner.

As one of the embodiments, according to the received movement trigger instruction of the target processing graphic element, the drag movement adsorption is realized.

When there is one target position within the adsorption distance between the target processing graphic element and the alignment reference object, in response to the movement trigger instruction of the target processing graphic element, when the distance between the target processing graphic element and a target position of the alignment reference object are within the adsorption distance, the target processing graphic element is controlled to move to the target position of the alignment reference object.

When there are a plurality of target positions within the adsorption distance between the target processing graphic element and the alignment reference object, in response to the movement trigger instruction of the target processing graphic element, when the distance between the target processing graphic element and a plurality of target positions of the alignment reference object are within the adsorption distance, the target processing graphic element is controlled to move to the target position closest to the target processing graphic element, so as to realize the movement adsorption and alignment.

As a second embodiment, a smart adsorption switch, an operation button, and the like are configured as operation control members at the canvas, the setting position, the operation bar of the display interface. According to the received trigger instruction of the second interactive control member, such as the adsorption switch, the target processing graphic element is controlled to move to realize automatic adsorption.

In response to the trigger of the second interactive control member, when the distance between the target processing graphic element and a target position of the alignment reference object is within the adsorption distance, the target processing graphic element is controlled to move to the target position of the alignment reference object to realize the automatic adsorption and alignment. Or, according to the received trigger of the second interactive control member, when the distance between the target processing graphic element and a plurality of target positions of the alignment reference object is within the adsorption distance, the target processing graphic element is controlled to move to the target position closest to the target processing graphic element to realize the automatic adsorption and alignment.

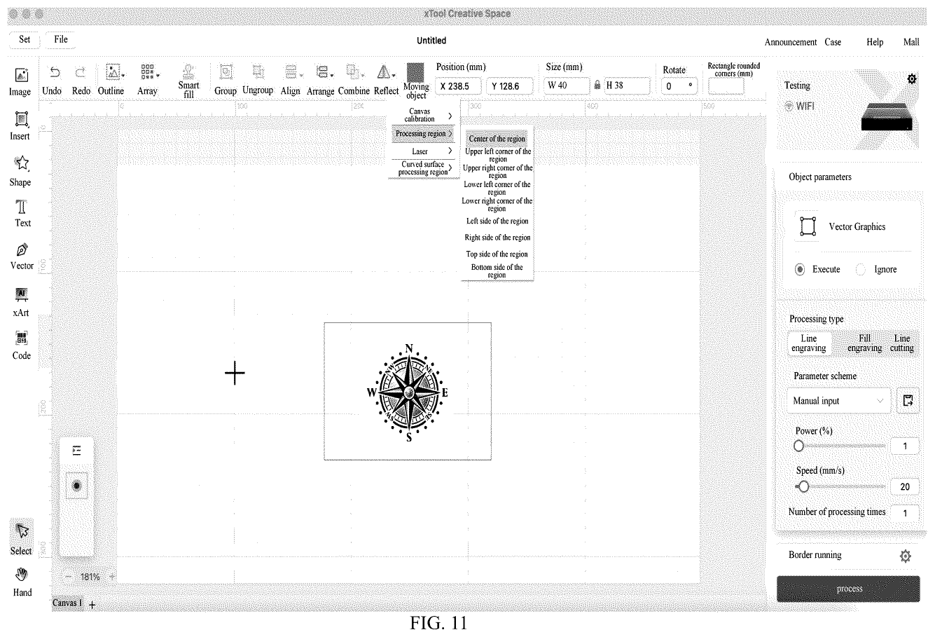

As shown in FIG. 11, in a third embodiment, a display interface displays a moving object interactive control member. In response to a trigger instruction of the moving object interactive control member, a plurality of moving object options such as “canvas”, “calibrated processing region”, “curved surface processing region”, and “auxiliary line” are displayed in the form of a menu, a list, and the like. A moving object determined from the plurality of moving object options is configured as an alignment reference object.

In response to the first operation sub-instruction, a plurality of moving object options are displayed through an expanded first-level menu, and according to a trigger instruction for one of the plurality of moving object options, a selected moving object is determined, and the selected moving object is determined as an alignment reference object. At least one position option corresponding to the alternative alignment position of the alignment reference object is displayed through an expanded secondary menu.

In response to the second operation sub-instruction for the position option, in an embodiment, in response to the selected trigger instruction for any one of the plurality of alternative alignment positions, the selected alternative alignment position is determined, and the selected alternative alignment position is determined as the target position required to be aligned and set on the alignment reference object, and the target processing graphic element is controlled to move to the target position required to be aligned and set on the alignment reference object, so as to realize the automatic alignment and movement of the target processing graphic element.

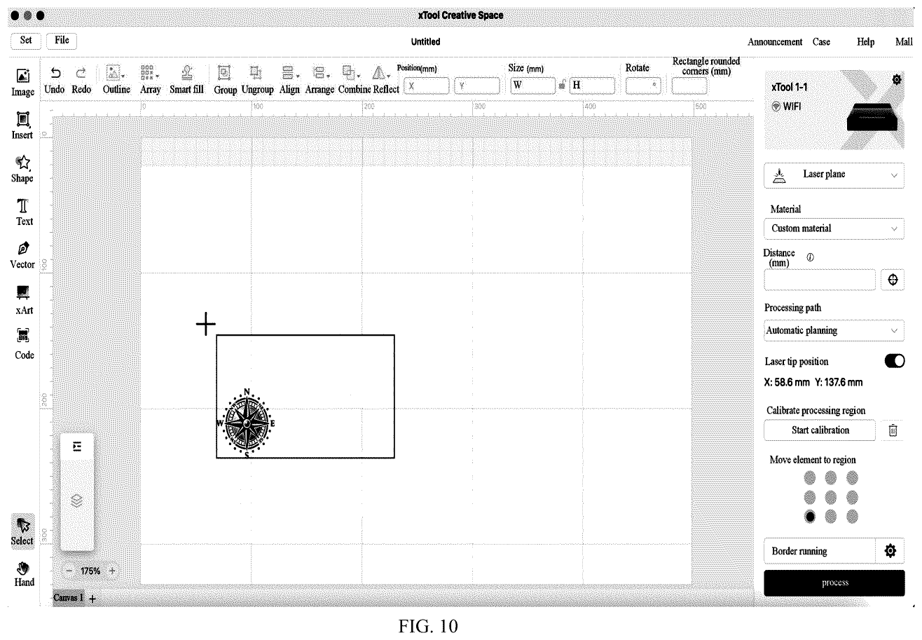

As shown in FIG. 10, in a fourth embodiment, the alignment reference object can be divided into a plurality of sub-regions such as the calibrated processing region. The display interface displays a plurality of position options corresponding to the sub-regions of the alignment reference object, and according to the trigger instruction of one of the plurality of position options of the first interactive control member, and the target processing graphic element is controlled to move, and the automatic movement adsorption is realized.

In response to the fourth operation sub-instruction of the first interactive control member, displaying a plurality of position options corresponding to a plurality of sub-regions of the alignment reference object on the display interface.

In response to the fifth operation sub-instruction of the position option, according to the trigger instruction of one of the plurality of position options, determining the selected sub-region, and determining the selected sub-region as the target position, and controlling the target processing graphic element to move to the selected sub-region to realize the automatic movement and alignment of the target processing graphic element.

The specific implementation of the above embodiment refers to the relevant contents of the above embodiments, which is not repeated here.

In an embodiment, the alignment reference object configured as the calibration position or the reference point of the target position, the processing tip calibration position such as the laser tip calibration position, or other positioning are used as an example. The method for arranging the regional element in the embodiment of the present application can be implemented by the following implementation methods.

In an embodiment, according to the received movement trigger instruction of the target processing graphic element, dragging and movement adsorption is realized.

In response to the movement trigger instruction of the target processing graphic element, the processing tip calibration position is configured as the target position. When the distance between the target processing graphic element and the processing tip calibration position is within the adsorption distance, the target processing graphic element is controlled to move to the processing tip calibration position to realize the movement adsorption and alignment.

As shown in FIG. 11, in a second embodiment, a display interface displays a moving object interactive control member, and in response to a trigger instruction of the moving object interactive control member, a plurality of moving object options, such as “laser tip calibration position”, other processing tip calibration positions and other alternative calibration points, are displayed in the form of a menu, a list, and the like. A moving object selected from the plurality of moving object options is determined as an alignment reference object.

In response to the third operation sub-instruction, the processing tip calibration position, the alternative calibration point, and the like displayed in the expanded first-level menu are used as moving objects, and any selected moving object is determined as the alignment reference object according to the third operation sub-instruction. The alignment reference object is determined as the target position, and the target processing graphic element is directly controlled to move to the position where the alignment reference object is located, so as to realize the automatic movement and alignment of the target processing graphic element.

The specific implementation of the above embodiment refers to the relevant contents of the above embodiments, which is not repeated here.

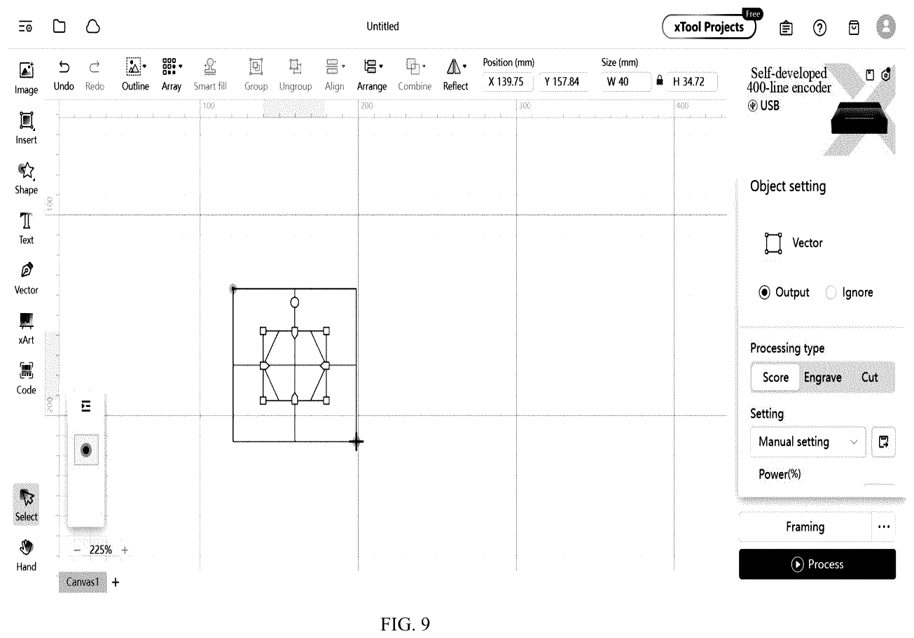

As shown in FIG. 9 to FIG. 13, the embodiment of the present application also provides a device for arranging a regional element, and the device for arranging a regional element includes a display module, a receiving module, and a generating module.

The display module is provided with a display interface. The display module can be a display or other display device. The receiving module can be a device for receiving an operation instruction such as a mouse, an input keyboard, a communication interface, and the like. The operation instruction includes at least a first operation instruction and a second operation instruction. The generating module is configured to have a data processing function, and is used to execute the method for arranging the regional element in the above embodiments according to the operation instruction.

Further, after completing the arrangement of all target processing graphic elements, the generating module is also used to determine the position of the target processing graphic element in the alignment reference object, and generate a scheme for arranging the regional element. The generated scheme for arranging the regional element can be a processing file which may be in but not limited to a gcode format or any other format.

In an embodiment, a display interface displays at least one of a first operation unit and a second operation unit. The first operation unit includes a first interactive control member, the first interactive control member has a plurality of position options. Each position option corresponds to a sub-region on an alignment reference object. The second operation unit includes a moving object interactive control member, which is used to display a plurality of moving objects through an expanded first-level menu, determine a selected moving object according to an operation instruction, and determine the selected moving object as an alignment reference object. When the selected alignment reference object is a processing region with one or more alignment positions, such as a calibrated processing region or an auxiliary line, at least one position option corresponding to an alternative alignment position of the alignment reference object is displayed through an expanded secondary menu. When the selected alignment reference object is a processing tip calibration position, such as a laser tip calibration position or other calibration positions, reference points, the selected alignment reference object is used as the target position.

The first operation unit can be set as a control button, an intelligent adsorption switch, and the like, or can also display the nine-grid or other a plurality of sub-regions divided from the alignment reference object, such as the calibration processing region, through the device sidebar, to specify the sub-region to be used as the target position. The second operation unit can be set as the top bar of the display interface. The first operation unit and the second operation unit can also be in gray arrangement when no object is selected. Taking the first operation unit as an example, the first operation unit displays a plurality of sub-regions, such as a plurality of grids, and the gray arrangement means that the displayed multiple sub-regions such as grids keep gray when no corresponding operation instruction is received. The first operation unit and the second operation unit can be set according to actual conditions, which are not limited here.

Since the device for arranging a regional element can be used to implement the above-mentioned method for arranging the regional element, it has at least all the beneficial effects brought by the technical solutions of the above-mentioned embodiments, which will not be repeated here.

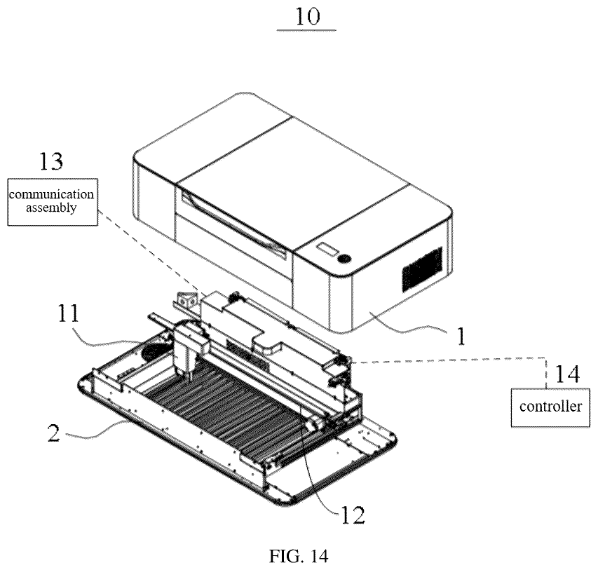

As shown in FIG. 14, the present application further provides a computer numerical control machine 10, which can be, but is not limited to, a laser cutting device, a laser engraving device, or a knife cutting device. The computer numerical control machine 10 includes a housing, a processing tip 11, a sliding rail 12, a communication assembly 13, and a controller 14. The housing includes an upper housing 1 and a bottom housing 2. The processing tip 11 can slide along the sliding rail 12. The processing tip 11 is used to move and process the surface of the processing material by emitting a processing light spot. The processing tip 11 can be, but is not limited to, a laser tip, a knife cutting tip, a cutting tip, a pen tip, and a drill tip. The sliding rail 12 is used to drive the processing tip to reciprocate along the X direction and/or the Y direction. The communication assembly 13 is used to receive a signal which is obtained according to the steps of the method for arranging the regional element in the above embodiments to align the position of the target processing graphic element with the position of the alignment reference object. The controller 14 controls the processing tip 11 to move on the sliding rail 12 to process the surface of the processing material according to the signal. The communication assembly 13 and the controller 14 are installed inside the computer numerical control machine 10, which is not visible from the perspective in FIG. 14, so they are shown by a dotted line connection block diagram.

In an embodiment, the housing of the computer numerical control machine 10, that is, the upper housing 1 and the bottom housing 2 as shown in FIG. 14, may enclose an internal space that can accommodate processing materials. The upper housing 1 can be detachably connected to or fixedly connected to the bottom housing 2, or the upper housing 1 and the bottom housing 2 are an integrally formed structure. In an embodiment, the upper housing 1 is further provided with a rotatable cover plate, and the user can operate the cover plate to open the internal space to put in or take out the processing material. Through the blocking and/or filtering effect of the upper housing 1 and the bottom housing 2, it is possible to prevent the laser emitted by the processing tip 11 from running out during operation to cause personal injury to the user. As shown in FIG. 14, the sliding rail 12 is provided in the above-mentioned internal space.

The computer numerical control machine 10 is connected to the host computer, which is used to provide a display interface and control the computer numerical control machine 10 to process the surface of the processing material. Or, the signal obtained according to the steps of the method for arranging the regional element is transmitted to the control unit of the numerical control machine 10 through the communication assembly of the numerical control machine 10, to process the surface of the processing material.

According to the embodiments in the present application, the process described with reference to the flowchart above can be implemented through a computer software program. For example, the embodiments disclosed in the present application may relate to a computer program product, which includes a computer program carried on a computer-readable medium, and the computer program includes a program code for executing the method shown in the flowchart. In such an embodiment, the computer program can be downloaded and installed from a network through a communication device, or installed from a storage device, or installed from a read only memory (ROM). When the computer program is executed by a processing device, the above functions defined in the method of the embodiments disclosed in the present application can be achieved.

The device for arranging a regional element in the present application adopts the method for arranging the regional element in the above embodiments, which can solve the problem that during the existing arranging process of the scheme for arranging the regional element, the target processing graphic element cannot accurately move to the target position where the target processing graphic element is required to be aligned and set, it is inconvenient to adjust the setting position of the target processing graphic element, and the arrangement efficiency is low. Compared with the related art, the beneficial effects of the device for arranging a regional element provided by the present application are the same as the beneficial effects of the method for arranging the regional element provided by the above embodiments, and other technical features of the device for arranging a regional element are the same as the features of the method of the previous embodiments, which will not be repeated here.

It should be understood that the various parts disclosed in the present application can be implemented by hardware, software, firmware or a combination thereof. In the description of the above implementation, specific features, structures, materials or characteristics can be combined in any one or a plurality of embodiments or examples by a suitable way.

The above contents are only some embodiments of the present application, but the scope of the present application is not limited thereto. Those skilled in the art can easily think of changes or replacements within the technical scope disclosed in the present application, which should be covered within the protection scope of the present application. Therefore, the scope of the present application shall be subject to the scope of the claims.

The control and coordination of the above parts can be achieved by using software instructions stored in a non-transitory computer-readable medium. When the software instruction is executed on one or a plurality of programmed processors, operations and generated functions in the above method can be performed. The program operations, processing steps, and associated data for implementing above embodiments can be achieved by using disk storage devices and other forms of storage devices. These storage devices include but are not limited to non-transitory storage media (where non-transitory storage is only intended to exclude propagation signals, not to exclude transient signals, since the propagation signals are erased by removing the power supply or by a specific erasure action). For example, the storage device can be the ROM device, the random access memory (RAM) device, the network storage device, the optical storage element, the magnetic storage element, the magneto-optical storage elements, the flash memory, the core memory and/or other equivalent volatile and non-volatile storage device.

In addition, to achieve the above purpose, the present application provides a non-transitory computer-readable storage medium, on which a calibration program is stored, and when the calibration program is executed by the processor, the method for arranging the regional element in the above embodiments is implemented.

The non-transitory computer-readable storage medium in the present application may be the USB flash disk, and is not limited to electrical, magnetic, optical, electromagnetic, infrared, or semiconductor systems, or devices, or any combination of the above devices. Computer-readable storage media may include, but are not limited to: electrical connections with one or a plurality of wires, portable computer disks, hard disks, RAM, ROM, erasable programmable read-only memories, optical fibers, portable compact disk read-only memories (CD-ROM), optical storage devices, magnetic storage devices, or any suitable combination of the above devices. In this embodiment, the non-transitory computer-readable storage medium may be any tangible medium containing or storing a program that can be executed by an instruction execution system, a system or a device, or can be used in conjunction with an instruction execution system, a system or a device. The program code contained on the non-transitory computer-readable storage medium may be transmitted through any appropriate medium, including but not limited to: wires, optical cables, radio frequency (RF), and the like, or may be transmitted through any suitable combination of the above medium.

The non-transitory computer-readable storage medium may be included in the device for arranging a regional element, or may exist independently without being assembled into the device for arranging a regional element.

The non-transitory computer-readable storage medium carries one or a plurality of programs. When one or a plurality of programs are executed by the device for arranging a regional element, the device for arranging a regional element is configured to obtain the distribution of points to be processed on the object to be processed, receive a first operation of a user to determine a target processing graphic element on a display interface, determine an alignment reference object, and in response to a second operation of the user, control the target processing graphic element to move to the target position of the alignment reference object after a target position of the alignment reference object is determined, so that the target processing graphic element is aligned with the target position. The second operation is used to designate the target position of the target processing graphic element that is required to be aligned.

Computer program code for performing the operations of the present application may be written in one or more programming languages or a combination thereof. The programming language includes object-oriented programming languages, such as Java, Smalltalk, C++, and conventional procedural programming languages, such as “C” language or similar programming languages. The program code may be executed entirely on the user's computer, or may be executed partially on the user's computer, or may be executed as a separate software package, or may be executed partially on the user's computer and partially on a remote computer, or may be executed entirely on a remote computer or a server. In the case of a remote computer, the remote computer may be connected to the user's computer through any type of network, including a local area network (LAN) or a wide area network (WAN), or may be connected to an external computer (for example, the Internet connection through the Internet service provider).

The flowcharts and block diagrams in the accompanying drawings illustrate the possible architecture, functions, and operations of the systems, methods, and computer program products according to various embodiments of the present application. In this case, each box in a flowchart or block diagram may represent a module, a program segment, or a portion of a code, which contains one or more executable instructions for implementing a specified logical function. It should also be noted that in some alternative implementations, the functions marked in the box may also occur in an order different from that marked in the accompanying drawings. For example, two successional boxes may actually be executed concurrently, and they may sometimes be executed in the opposite order, which will depend on the involved functions. It should also be noted that each box in a block diagram and/or flowchart, and a combination of boxes in a block diagram and/or flowchart, may be implemented by a dedicated hardware-based system that performs a specified function or operation, or may be implemented by a combination of dedicated hardware and computer instructions.

The modules in the embodiments of the present application may be implemented by software or by hardware. The name of the module does not constitute a limitation on the unit in some cases.

The readable storage medium in the present application is a computer-readable storage medium, which stores computer-readable program instructions (namely the computer programs) for executing the above-mentioned method for arranging the regional element, and can solve the problems that during the existing arranging process of the scheme for arranging the regional element, the target processing graphic element cannot accurately move to the target position where the target processing graphic element is required to be aligned and set, it is inconvenient to adjust the setting position of the target processing graphic element, and the arrangement efficiency is low. Compared with the related art, the beneficial effects of the computer-readable storage medium provided by the present application are the same as the beneficial effects of the method for arranging the regional element provided by the above embodiments, which will not be repeated here.

The embodiment of the present application provides a computer program product, including a computer program which implements the steps of the method for arranging the regional element as described above when the computer program is executed by a processor.

The computer program product provided by the present application can solve the problems that during the existing arranging process of the scheme for arranging the regional element, the target processing graphic element cannot accurately move to the target position where the target processing graphic element is required to be aligned and set, it is inconvenient to adjust the setting position of the target processing graphic element, and the arrangement efficiency is low. Compared with the related art, the beneficial effects of the computer program product provided by the present application are the same as the beneficial effects of the method for arranging the regional element provided by the above embodiments, which will not be repeated here.

The above are only some embodiments of the present application, and do not limit the scope of the present application thereto. Under the concept of this application, any equivalent structural transformation made according to the description and drawings of the present application, or direct/indirect application in other related technical fields shall fall within the claimed scope of the present application.

What is claimed is:

1. A method for arranging a regional element, comprising:
determining a target processing graphic element on a display interface according to a received first operation instruction; and
determining an alignment reference object, and in response to a second operation instruction, controlling the target processing graphic element to move to a target position of the alignment reference object after determining the target position of the alignment reference object, to align the target processing graphic element with the target position, wherein the second operation instruction is configured to specify a target position to be aligned of the target processing graphic element.

2. The method according to claim 1, wherein in response to the second operation instruction, controlling the target processing graphic element to move to the target position of the alignment reference object after determining the target position of the alignment reference object, to align the target processing graphic element with the target position comprises:
determining the target position to be aligned on the alignment reference object in response to the second operation instruction; and
controlling the target processing graphic element to move to the target position to be aligned on the alignment reference object, to align the target processing graphic element with the target position.

3. The method according to claim 2, wherein the second operation instruction comprises a first operation sub-instruction and a second operation sub-instruction, and the determining the alignment reference object, and in response to the second operation instruction, controlling the target processing graphic element to move to the target position of the alignment reference object after determining the target position of the alignment reference object, to align the target processing graphic element with the target position comprises:
displaying a plurality of moving object options, and configuring a moving object determined from the plurality of moving object options as the alignment reference object, wherein each moving object option corresponds to one moving object displayed on the display interface, and the moving object comprises a canvas, a calibrated processing region, a curved surface processing region, and an auxiliary line;
in response to the first operation sub-instruction, displaying at least one position option corresponding to the alignment reference object, wherein each position option corresponds to one alternative alignment position on the alignment reference object;
in response to the second operation sub-instruction corresponding to a position option, configuring the alternative alignment position determined from the plurality of position options as the target position to be aligned on the alignment reference object; and
controlling the target processing graphic element to move to the target position to be aligned on the alignment reference object, to align the target processing graphic element with the target position.

4. The method according to claim 2, wherein the second operation instruction comprises a third operation sub-instruction, and the determining the alignment reference object, and in response to the second operation instruction, controlling the target processing graphic element to move to the target position of the alignment reference object after determining the target position of the alignment reference object, to align the target processing graphic element with the target position comprises:
displaying a plurality of moving object options, and configuring a moving object determined from the plurality of moving object options as the alignment reference object, wherein each moving object option corresponds to one moving object displayed on the display interface, and the moving object comprises a processing tip calibration position and an alternative calibration point; and
in response to the third operation sub-instruction, configuring the alignment reference object as the target position, and controlling the target processing graphic element to move to the target position, to align the target processing graphic element with the target position.

5. The method according to claim 1, wherein a first interactive control member is displayed on the display interface, the second operation instruction comprises a fourth operation sub-instruction and a fifth operation sub-instruction, and in response to the second operation instruction, controlling the target processing graphic element to move to the target position of the alignment reference object after determining the target position of the alignment reference object, to align the target processing graphic element with the target position comprises:
in response to the fourth operation sub-instruction of the first interactive control member, displaying a plurality of position options on the display interface, each position option corresponding to a sub-region on the alignment reference object; and
in response to the fifth operation sub-instruction of the position option, configuring a sub-region determined from the plurality of position options as the target position, controlling the target processing graphic element to move to the target position, to align the target processing graphic element with the target position.

6. The method according to claim 1, further comprising:
in response to the first operation instruction, creating a processing graphic element and an alignment reference object on the display interface; and
establishing a plurality of target positions on the alignment reference object according to a position parameter of the alignment reference object, and establishing a plurality of alignment anchor points on the processing graphic element, to make positions of the plurality of alignment anchor points on the processing graphic element correspond to positions of the plurality of target positions on the alignment reference object.

7. The method according to claim 6, wherein in response to the second operation instruction, controlling the target processing graphic element to move to the target position of the alignment reference object after determining the target position of the alignment reference object, to align the target processing graphic element with the target position comprises:
in response to the second operation instruction, determining a corresponding alignment anchor point on the target processing graphic element according to the target position determined by the second operation instruction, and controlling the target processing graphic element to move, to make a corresponding alignment anchor point on the target processing graphic element align and overlap with a determined target position.

8. The method according to claim 1, wherein a second interactive control member is displayed on the display interface, the second operation instruction comprises a trigger instruction for the second interactive control member, and in response to the trigger instruction for the second interactive control member, controlling the target processing graphic element to move to the target position of the alignment reference object after determining the target position of the alignment reference object, to align the target processing graphic element with the target position comprises:
in response to the trigger instruction for the second interactive control member, when a distance between the target processing graphic element and a target position of the alignment reference object is within an adsorption distance, controlling the target processing graphic element to move to the target position of the alignment reference object; or
in response to the trigger instruction for the second interactive control member, when a distance between the target processing graphic element and a plurality of target positions of the alignment reference object is within an adsorption distance, controlling the target processing graphic element to move to a target position closest to the target processing graphic element.

9. The method according to claim 1, wherein the second operation instruction comprises a movement trigger instruction, and the determining the alignment reference object, and in response to the second operation instruction, controlling the target processing graphic element to move to the target position of the alignment reference object after determining the target position of the alignment reference object comprises:
acquiring an actual position of the processing tip, generating a processing tip calibration position corresponding to the actual position of the processing tip on the display interface, and determining the alignment reference object with the processing tip calibration position; and
in response to the movement trigger instruction of the target processing graphic element, configuring the processing tip calibration position as the target position, when a distance between the target processing graphic element and the processing tip calibration position is within an adsorption distance, controlling the target processing graphic element to move to the processing tip calibration position.

10. The method according to claim 1, wherein the second operation instruction comprises a movement trigger instruction, and in response to the second operation instruction, controlling the target processing graphic element to move to the target position of the alignment reference object after determining the target position of the alignment reference object comprises:
in response to the movement trigger instruction of the target processing graphic element, when a distance between the target processing graphic element and a target position of the alignment reference object is within an adsorption distance, controlling the target processing graphic element to move to the target position of the alignment reference object; or when a distance between the target processing graphic element and a plurality of target positions of the alignment reference object is within an adsorption distance, controlling the target processing graphic element to move to a target position closest to the target processing graphic element.

11. The method according to claim 8, wherein before in response to the second operation instruction, controlling the target processing graphic element to move to the target position of the alignment reference object after determining the target position of the alignment reference object, to align the target processing graphic element with the target position, the method further comprises:
in response to the movement trigger instruction for the target processing graphic element, when a distance between the target processing graphic element and one or a plurality of target positions is within the adsorption distance, highlighting the target position.

12. The method according to claim 1, wherein the alignment reference object comprises at least one of the following:
a canvas, a calibrated processing region, a curved surface processing region, and an auxiliary line.

13. The method according to claim 12, wherein when the alignment reference object is the calibrated processing region, the determining the alignment reference object comprises:
based on an actual processing region calibrated through the processing tip, generating a calibrated processing region corresponding to the actual processing region on a canvas of the display interface, and determining a generated calibrated processing region as the alignment reference object.

14. The method according to claim 1, wherein after the controlling the target processing graphic element to move to the target position of the alignment reference object, to align the target processing graphic element with the target position, the method further comprises:
in response to a third operation instruction, determining a position of the target processing graphic element on the alignment reference object, and generating a scheme for arranging the regional element.

15. A computer numerical control machine, comprising:
a sliding rail;
a processing tip slidably provided at the sliding rail;
a communication assembly configured to receive a signal, wherein the signal is obtained through the method for arranging the regional element according to claim 1 to align the target processing graphic element with the alignment reference object; and
a controller configured to control the processing tip to move on the sliding rail to process a surface of a processing material based on the signal.

16. A system, comprising:
at least one data processor;
at least one non-transitory computer-readable storage medium, wherein a program instruction stored on the non-transitory computer-readable storage medium is executed by the at least one data processor, to make the system be configured to:
determine a target processing graphic element on a display interface according to a received first operation instruction; and
determine an alignment reference object, and in response to a second operation instruction, control the target processing graphic element to move to a target position of the alignment reference object after determine the target position of the alignment reference object, to align the target processing graphic element with the target position, wherein the second operation instruction is configured to specify the target position of the target processing graphic element to be aligned.

17. The system according to claim 16, wherein in response to the second operation instruction, controlling the target processing graphic element to move to the target position of the alignment reference object after determining the target position of the alignment reference object, to align the target processing graphic element with the target position comprises:
determining the target position to be aligned on the alignment reference object in response to the second operation instruction; and
controlling the target processing graphic element to move to the target position to be aligned on the alignment reference object, to align the target processing graphic element with the target position.

18. The system according to claim 17, wherein the second operation instruction comprises a first operation sub-instruction and a second operation sub-instruction, and the determining the alignment reference object, and in response to the second operation instruction, controlling the target processing graphic element to move to the target position of the alignment reference object after determining the target position of the alignment reference object, to align the target processing graphic element with the target position comprises:
displaying a plurality of moving object options, and configuring a moving object determined from the plurality of moving object options as the alignment reference object, wherein each moving object option corresponds to one moving object displayed on the display interface, and the moving object comprises a canvas, a calibrated processing region, a curved surface processing region, and an auxiliary line;
in response to the first operation sub-instruction, displaying at least one position option corresponding to the alignment reference object, wherein each position option corresponds to one alternative alignment position on the alignment reference object;
in response to the second operation sub-instruction corresponding to a position option, configuring the alternative alignment position determined from the plurality of position options as the target position to be aligned on the alignment reference object; and
controlling the target processing graphic element to move to the target position to be aligned on the alignment reference object, to align the target processing graphic element with the target position.

19. The system according to claim 17, wherein the second operation instruction comprises a third operation sub-instruction, and the determining the alignment reference object, and in response to the second operation instruction, controlling the target processing graphic element to move to the target position of the alignment reference object after determining the target position of the alignment reference object, to align the target processing graphic element with the target position comprises:
displaying a plurality of moving object options, and configuring a moving object determined from the plurality of moving object options as the alignment reference object, wherein each moving object option corresponds to one moving object displayed on the display interface, and the moving object comprises a processing tip calibration position and an alternative calibration point; and
in response to the third operation sub-instruction, configuring the alignment reference object as the target position, and controlling the target processing graphic element to move to the target position, to align the target processing graphic element with the target position.

20. A non-transitory computer-readable storage medium, wherein a computer program is stored on the non-transitory computer-readable storage medium, and when the computer program is executed by a processor, the method for arranging the regional element according to claim 1 is implemented.
